(19) United States
(12) Patent Application Publication
(10) Pub. No.: US 2024/0267318 A1
(43) Pub. Date: Aug. 8, 2024

(54) APPARATUS COMPRISING A PLURALITY OF INTERFACE DEVICES AND OPERATING METHOD FOR THIS PURPOSE

(71) Applicant: Robert Bosch GmbH, Stuttgart (DE)

(72) Inventors: Felix Fellhauer, Stuttgart (DE); Sebastian Hoeppner, Dresden (DE); Stephan Hartmann, Dresden (DE); Jean Noel, Valbonne Sophia-Antipolis (FR); Markus Winter, Dresden (DE)

(21) Appl. No.: 18/292,283

(22) PCT Filed: Aug. 11, 2022
(86) PCT No.: PCT/EP2022/072502

§ 371 Date: Jan. 25, 2024

(30) Foreign Application Priority Data
Aug. 17, 2021 (DE) 10 2021 208 994.1

(51) Int. Cl. H04L 43/50; H04L 43/0823; H04L 43/087

(52) U.S. Cl. CPC H04L 43/50; H04L 43/0847; H04L 43/087

(57) ABSTRACT

An apparatus including a plurality of interface devices. The plurality of interface devices each include a first connection device for connecting to a transmission medium. A first interface device of the plurality of interface devices is configured to at least temporarily output at least a first signal, for example a test signal, of at least one second interface device of the plurality of interface devices via its first connection device.

### FIELD

The present invention relates to an apparatus comprising a plurality of interface devices.

The present invention also relates to a method for operating an apparatus comprising a plurality of interface devices.

### SUMMARY

Embodiment examples of the present invention relate to an apparatus comprising a plurality of interface devices, wherein the plurality of interface devices each comprise a first connection device for connecting to a transmission medium, wherein a first interface device of the plurality of interface devices is configured to at least temporarily output at least a first signal, for example a test signal, of at least one second interface device of the plurality of interface devices via its first connection device.

In some embodiment examples of the present invention, there is therefore no need to provide separate connections, for example test connections, e.g. for testing purposes, e.g. for at least temporarily connecting a test device, because the first signal, which can, for instance, be an internal signal of the apparatus, e.g. of the second interface device, can be output at least temporarily via the existing first connection device of the first interface device.

In other embodiment examples of the present invention, it can, for example, be provided that, during regular operation of the apparatus, useful data are output via the first connection device of the first interface device, whereas, outside of regular operation, for example in the context of manufacturing and/or diagnosis of the apparatus, the first signal (and/or another, for instance internal, signal of the apparatus) can be output instead of the useful data, for example of. In other embodiment examples, it is thus possible to reduce the number of test connections of the apparatus, which, for example in some conventional apparatuses, enable a connection of an external device, e.g., a test device, to inherently internal signals of the apparatus or to inherently internal signals of at least one of its plurality of (e.g. fully integrated into the apparatus) interface devices. In other words, fewer test connections can be provided in other embodiment examples than in some conventional apparatuses, which can, for instance, reduce complexity and/or manufacturing time and/or associated costs.

In other embodiment examples of the present invention, it is provided that the plurality of interface devices are each configured as Ethernet interface devices, for example automotive Ethernet interface devices, for example according to or based on at least one of the following standards: a) IEEE 802.3bw, b) IEEE 802.bp, c) IEEE 802.3ch, d) IEEE 802.3cy, e) IEEE 802.3cg. The plurality of interface devices are, for example, configured to carry out at least one respective function of layer 1 (“bit transmission layer”, “physical layer”) of the ISO/OSI reference model, for instance.

In other embodiment examples of the present invention, it is provided that a first signal connection is provided, via which the first signal can at least temporarily be transmitted from the second interface device to the first interface device, wherein the first signal connection is provided internally in the apparatus, for example.

In other embodiment examples of the present invention, it is provided that the first signal connection is configured for transmitting or exchanging differential signals. In other embodiment examples, it can also be provided that the first signal connection is, for example alternatively or additionally, configured for transmitting or exchanging non-differential (“single ended”) signals.

In other embodiment examples of the present invention, it is provided that the first signal connection is configured for transmitting or exchanging a plurality of differential and/or non-differential signals.

In other embodiment examples of the present invention, it is provided that the first signal can be generated locally in the second interface device of the plurality of interface devices or can be derived from at least one other signal, for example of the second interface device, wherein the first signal is a clock signal, for example.

In other embodiment examples of the present invention, the second interface device can, for example, comprise at least one clock generator and/or at least one clock recovery unit, which is integrated into the interface device, for instance. The at least one clock generator and/or the at least one clock recovery unit can, for example, be configured to generate or “recover” a clock signal in a conventional manner during regular operation of the apparatus.

Whereas, in some conventional interface devices, such a clock signal and/or another signal which is internal with respect to the interface device or the apparatus can possibly only be made accessible via separate test connections of an external unit, e.g., a test device, in other embodiment examples of the present invention, the clock signal or a possibly existing other, for example internal, signal of the interface device or the apparatus can at least temporarily be passed to the first interface device as the first signal and output via its first connection device, i.e., for instance made available to an external test device.

In other embodiment examples of the present invention, the principle of the embodiments can also be applied to other, e.g. internal, signals of the interface device or the apparatus, so that the clock signal or any other available (internal) signals and useful signals of the respective interface device can be output, for example alternately in terms of time, via their first connection device.

In other embodiment examples of the present invention, it is provided that the first interface device is configured to at least temporarily receive the first signal from the second interface device, for example via a or the first signal connection.

In other embodiment examples of the present invention, it is provided that the first interface device comprises a second connection device at least for receiving the first signal (and/or at least one further, for example internal, signal) from the second interface device. In other embodiment examples, the first interface device can also receive, via the second connection device, one or more, e.g. internal, signals, e.g. clock signals, of at least one (for example all) further, i.e. other than the second, interface device, which in other embodiment examples can be output at least temporarily via the first connection device of the first interface device, e.g. analogous to the first signal.

In other embodiment examples of the present invention, it is provided that the first interface device is configured to at least temporarily output a second signal, for example a test signal, via the second connection device to at least one further interface device of the plurality of interface devices, for example to the second interface device. In other embodiment examples, the second interface device, for instance, can be configured, for example in a manner comparable to the first interface device, to at least temporarily receive a signal from another, e.g. the first (and/or at least one further) interface device, and to output it, for example via the first connection device of the second interface device, for example to an external unit.

In other embodiment examples of the present invention, it is provided that the first interface device is configured to output the first signal to at least one further interface device of the plurality of interface devices. The first signal can thus be forwarded, e.g. by means of the first interface device, to the at least one further interface device, for example for at least temporarily outputting the first signal via a first connection device of the at least one further interface device, for example to an external unit.

In other embodiment examples of the present invention, it is provided that the first signal is not, e.g. not simultaneously or not at all, output via the first connection device of the forwarding first interface device when the first signal is forwarded to the at least one further interface device.

In other embodiment examples of present invention, it is provided that the first signal is output, e.g. simultaneously, via the first connection device of the forwarding first interface device when the first signal is forwarded to the at least one further interface device. In some embodiment examples, the first signal can therefore be output via a respective first connection device of both the forwarding interface device and the at least one further interface device receiving the forwarded first signal, for instance; for example simultaneously, for example to a plurality of test devices.

In other embodiment examples of the present invention, it is provided that the first interface device comprises a line driver for the first connection device, wherein the first interface device is configured to at least temporarily supply the first signal to the line driver.

In other embodiment examples of the present invention, it is provided that the first interface device comprises a multiplexer device, via which the first signal or at least one further signal, for example a useful signal, can at least temporarily be supplied to the first connection device and/or a or the line driver, for example selectively. In other embodiment examples, the multiplexer device can be controlled for regular operation in such a way that the useful signal can be output via the line driver or the first connection device, for instance. In other embodiment examples, the multiplexer device can be controlled for a test operation in such a way that the first signal or test signal (e.g. clock signal of another interface device) can be output via the line driver or the first connection device, for instance.

In other embodiment examples of the present invention, it is provided that the second connection device comprises at least one of the following elements: a) a first input for receiving at least one signal, for example the first signal, from the second interface device, b) a first output for sending and/or forwarding at least one signal to the second interface device, c) a second input for receiving at least one signal, for example a third signal, from at least one further interface device, d) a second output for sending or forwarding at least one signal to the at least one further interface device. A plurality of interface devices of the apparatus can thus be efficiently connected to one another in order to, at least temporarily, supply e.g. respective, e.g. internal signals to at least one other interface device, for instance for at least temporarily output via the first connection device of the at least one other interface device and/or for forwarding to at least one further interface device.

In other embodiment examples of the present invention, it is provided that a) the first input and the first output are disposed on a same first side of the first interface device, for instance a semiconductor substrate of the interface device, and/or that b) the second input and the second output are disposed on a same second side of the first interface device, for instance a or the semiconductor substrate of the interface device, wherein the second side is opposite to the first side, for example.

In other words, in other embodiment examples of the present invention, the output and input of the same side can thus respectively be disposed in such a way that, if the same layout (for the interface device) is disposed adjacently, the outputs and inputs of the respective neighbors are directly next to one another, i.e. can be connected easily or efficiently, for instance.

Other embodiment examples of the present invention relate to a system, for example a one-chip system or system on a chip, SoC, comprising at least one apparatus according to the embodiments. This, for instance, makes it possible to implement communication devices comprising a plurality of interface devices, for example for embedded systems, for example for vehicles, the internal signals of which can be made available, e.g. efficiently, at least temporarily, to an external unit using at least one existing first connection device of at least one interface device, for example for testing purposes, e.g. for a certification.

In other embodiment examples of the present invention, the system is configured as an automotive Ethernet SoC, for example; i.e. a single-chip Ethernet communication device for the automotive sector.

In other embodiment examples of the present invention, the apparatus and/or the system can optionally also include devices for executing functions of higher ISO/OSI layers, e.g. layer 2, 3, etc. In other embodiment examples, the apparatus and/or the system or the respective plurality of interface devices can, e.g. exclusively, comprise devices for executing functions of the ISO/OSI layer 1.

Other embodiment examples of the present invention relate to a control device, for example for a vehicle, for example a motor vehicle, comprising at least one apparatus according to the embodiments and/or at least one system according to the embodiments.

Other embodiment examples of the present invention relate to a method for operating an apparatus comprising a plurality of interface devices, wherein the plurality of interface devices each comprise a first connection device for connecting to a transmission medium, wherein the apparatus is configured according to the embodiments, for example, wherein the method comprises: at least temporarily outputting at least a first signal, for example a test signal, of at least one second interface device of the plurality of interface devices via the first connection device.

In other embodiment examples of the present invention, it is provided that the method comprises: providing and/or generating the first signal locally in the second interface device, for example by means of a clock generator and/or a clock recovery unit.

In other embodiment examples of the present invention, it is provided that the method comprises at least one of the following elements: a) at least temporarily, receiving the first signal from the second interface device, b) outputting the first signal via the first connection device, c) forwarding the first signal to at least one further interface device, checking the first signal.

In other embodiment examples of the present invention, it is provided that, e.g. alternatively or additionally for checking or certification purposes, an interface device of the apparatus checks a signal of at least one other interface device, for example without outputting it via its first connection device and/or forwarding it.

In other embodiment examples of the present invention, the check can be carried out when the apparatus is activated, for instance, and/or repeatedly, for example periodically, during operation.

In other embodiment examples of the present invention, for instance, one, e.g. specific, interface device, one or more, e.g. internal, signals of at least one other interface device, for example multiple other interface devices, for example all of the other interface devices of the plurality of interface devices, can be checked. The respective signals can be supplied to the checking interface device as described above, for example; for instance at least temporarily via the (internal) signal connection or the connections described above as examples.

In other embodiment examples of the present invention, the check can also be carried out by a test device of the apparatus, which is connected to at least one interface device similarly to how the interface devices are connected to one another, in order to exchange the (internal) signals. In other embodiment examples, for example when the apparatus is integrated into a system, e.g. Soc, the check can also be carried out by a, for example higher-level, test device of the SoC.

In other embodiment examples of the present invention, an error response can be initiated by the checking device if the check reveals a faulty signal.

In other embodiment examples of the present invention, checking, so to speak, enables a self-test of the apparatus or the system, e.g. relating to internal signals of the apparatus or its interface devices.

In other embodiment examples of the present invention, it is provided that the first interface device comprises a line driver for the first connection device and that the method comprises: at least temporarily supplying the first signal to the line driver and outputting the first signal through the line driver to the first connection device.

In other embodiment examples of the present invention, it is provided that the first interface device comprises a multiplexer device, and that the method comprises: a) at least temporarily supplying, by means of the multiplexer device, the first signal to the first connection device and/or to a line driver for the first connection device, b) at least temporarily supplying, by means of the multiplexer device, at least one further signal, for example a useful signal, to the first connection device and/or to the line driver for the first connection device. In other embodiment examples of the present invention, it is provided that the method comprises: connecting the second interface device to an external interface device (link partner), wherein the link partner is configured as a master, for example, and wherein the second interface device is configured as a slave, for example, shifting, for example by means of configuration, the first interface device into an operating mode, for example a test mode, in which the first interface device is configured to receive the first signal of the second interface device and output it via the first connection device of the first interface device, connecting a test device to the first connection device of the first interface device, and, optionally, receiving and/or evaluating the first signal output via the first connection device of the first interface device by means of the test device.

Other embodiment examples of the present invention relate to a use of the apparatus according to the embodiments and/or the system according to the embodiments and/or the control device according to the embodiments and/or the method according to the embodiments for at least one of the following elements: a) at least temporarily outputting a first signal of the second interface device and/or a signal of at least one further interface device via the first connection device, for example to a test device, b) forwarding the first signal of the second interface device and/or a signal of at least one further interface device, for example to a device which is external to the apparatus, for example a test device, c) at least temporarily using the first connection device to output signals other than useful signals, for example to output test signals, for example to a device which is external to the apparatus, for example a test device, d) double use of the first connection device for at least temporarily outputting useful signals and for at least temporarily outputting test signals for example to a device which is external to the apparatus, for example a test device, e) reducing a number of connection elements of the apparatus, for example for connecting to at least one external component, f) ascertaining at least one property of the first signal and/or at least one further signal of at least one interface device of the plurality of interface devices, wherein the at least one property comprises at least one of the following elements, for example: f1) frequency, f2) frequency stability, f3) fluctuation, for example clock fluctuation, for example jitter, for example without the use or presence of a separate test connection for outputting the first signal and/or the at least one further signal of the at least one interface device of the plurality of interface devices.

Further features, possible applications and advantages of the present invention emerge from the following description of embodiment examples of the present invention, which are shown in the figures. All described or depicted features by themselves or in any combination constitute the subject matter of the present invention, regardless of their formulation or representation in the description or in the figures.

### BRIEF DESCRIPTION OF THE DRAWINGS

FIG. 1 shows schematically a simplified block diagram according to embodiment examples of the present invention.

FIG. 2 shows schematically a simplified block diagram according to embodiment examples of the present invention.

FIG. 3 shows schematically a simplified block diagram of a system on a chip, SoC, according to embodiment examples of the present invention.

FIG. 4 shows schematically a simplified block diagram according to embodiment examples of the present invention.

FIG. 5 shows schematically a simplified block diagram of a system according to embodiment examples of the present invention.

FIG. 6 shows schematically a simplified flowchart according to embodiment examples of the present invention.

FIG. 7 shows schematically a simplified flow chart according to embodiment examples of the present invention.

FIG. 8 shows schematically, a simplified flow chart according to embodiment examples according to the present invention.

FIG. 9 shows schematically, a simplified flow chart according to embodiment examples of the present invention.

FIG. 10 shows schematically a simplified flow chart according to embodiment examples of the present invention.

FIG. 11 shows schematically a simplified flow chart according to embodiment examples of the present invention.

FIG. 12 shows schematically aspects of uses according to embodiment examples of the present invention.

FIG. 13 shows schematically a simplified block diagram according to embodiment examples of the present invention.

FIG. 14 shows schematically a control device according to embodiment examples of the present invention in an example of a target system.

### DETAILED DESCRIPTION OF EXAMPLE EMBODIMENTS

Embodiment examples, FIG. 1, relate to an apparatus 100 comprising a plurality of interface devices 110, 120, . . . , wherein the plurality of interface devices 110, 120, 130, . . . each comprise a first connection device 112, 122 for connecting to a transmission medium M1, M2, wherein a first interface device 110 of the plurality of interface devices is configured to at least temporarily output at least a first signal S-1, for example a test signal, of at least one second interface device 120 of the plurality of interface devices via its first connection device 112.

In some embodiment examples, there is therefore no need to provide separate connections, for example test connections, e.g. for testing purposes, e.g. for at least temporarily connecting a test device PE, because the first signal S-1, which can, for instance, be an internal signal of the apparatus 100, e.g. of the second interface device 120, can be output at least temporarily via the existing first connection device 112 of the first interface device 110. In a test operation, the first connection device 112 can be connected for this purpose to an (external) test device PE via the medium M1, e.g. a data cable, which can acquire and, if necessary, evaluate the output signal S-1.

In other embodiment examples, it can, for example, be provided that, during regular operation of the apparatus 100 or the first interface device 110, i.e. outside the example test operation, useful data are output via the first connection device 112 of the first interface device 110, e.g. again via a data cable M1, but this time not to the test device PE, but, for instance, instead to a regular link partner VP1 for exchanging (sending and/or receiving) the useful data.

Thus, in other embodiment examples, e.g. outside of regular operation, for example in the context of manufacturing and/or diagnosis of the apparatus 100, instead of the useful data, for instance the first signal S-1 (and/or a further, e.g. internal, signal of the apparatus) can be output, e.g. to the test device PE. In other embodiment examples, it is thus possible to reduce the number of test connections (not depicted) of the apparatus 100, which, for example in some conventional apparatuses, enable a connection of an external device, e.g. a test device, to inherently internal signals S-1 of the apparatus or to inherently internal signals of at least one of its plurality of (e.g. fully integrated into the apparatus) interface devices. In other words, fewer test connections can be provided in other embodiment examples than in some conventional apparatuses, which can, for instance, reduce complexity and/or manufacturing time and/or associated costs.

In other embodiment examples, it is provided that the plurality of interface devices 110, 120, . . . are each configured as Ethernet interface devices, for example automotive Ethernet interface devices, for example according to or based on at least one of the following standards: a) IEEE 802.3bw, b) IEEE 802.bp, c) IEEE 802.3ch, d) IEEE 802.3cy, e) IEEE 802.3cg. The plurality of interface devices are, for example, configured to carry out at least one respective function of layer 1 (“bit transmission layer”, “physical layer”) of the ISO/OSI reference model, for instance. In other embodiment examples, other types of interfaces are possible as well.

In other embodiment examples, FIG. 1, it is provided that a first signal connection SV1 is provided, via which the first signal S-1 can at least temporarily be transmitted from the second interface device 120 to the first interface device 110; see also the double arrows a1, a2, which each symbolize a connection of the respective interface devices 110, 120 to the first signal connection SV1. The first signal connection SV1 provided internally in the apparatus 100 in particular does not comprise any test connections for external device, for instance.

In other embodiment examples, it is provided that the first signal connection SV1 is configured for transmitting or exchanging differential signals. The first signal S-1 can therefore be exchanged particularly reliably between the interface devices 110, 120 and a used test device PE, for instance, so that any evaluations carried out by the test device PE are affected as little as possible by the transmission of the first signal S-1 via the first signal connection SV1.

In other embodiment examples, it can also be provided that the first signal connection SV1 is, for example alternatively or additionally, configured for transmitting or exchanging non-differential (“single ended”) signals.

In other embodiment examples, it is provided that the first signal connection SV1 is configured for transmitting or exchanging a plurality of differential and/or non-differential signals.

In other embodiment examples, FIG. 1, it is provided that the first signal S-1 can be generated locally in the second interface device 120 or can be derived from at least one other signal, for example of the second interface device 120, wherein the first signal S-1 is a clock signal, for example.

In other embodiment examples, the second interface device 120 can, for example, comprise at least one clock generator 125 and/or at least one clock recovery unit, which is integrated into the interface device 120, for instance. The at least one clock generator 125 and/or the at least one clock recovery unit can, for example, be configured to generate or “recover” a clock signal in a conventional manner during regular operation of the apparatus 100. In other embodiment examples, at least one other interface device can also comprise such a clock generator.

Whereas, in some conventional interface devices, such a clock signal S-1 and/or another signal which is internal with respect to the interface device 120 or the apparatus 100 can possibly only be made accessible via separate test connections (not depicted) of an external unit, e.g. a test device PE, in other embodiment examples, the clock signal S-1 or a possibly existing other, for example internal, signal of the interface device 120 or the apparatus 100 can at least temporarily be passed to the first interface device 110 as the first signal S-1 and output via its first connection device 112, i.e. for instance made available to an external test device PE.

In other embodiment examples, the second interface device 120 can, for example, also output useful signals (not depicted) to an external link partner VP2, or exchange (send and/or receive) them with said link partner, via its first connection device 122 and the medium M2 outside of such a test operation.

In other embodiment examples, the principle of the embodiments can also be applied to other, e.g. internal, signals of the interface device 110, 120, . . . or the apparatus 100, so that the clock signal or any other available (internal) signals and useful signals of the respective interface device can be output, for example alternately in terms of time, via their first connection device.

In other embodiment examples, FIG. 1, it is provided that the first interface device 110 is configured to at least temporarily receive the first signal S-1 from the second interface device 120, for example via the first signal connection SV1.

In other embodiment examples, FIG. 1, the apparatus 100 can also comprise more than the two interface devices 110, 120 shown here as an example, wherein the principle of the embodiments can, for example also be applied to the more than two interface devices 110, 120, . . . .

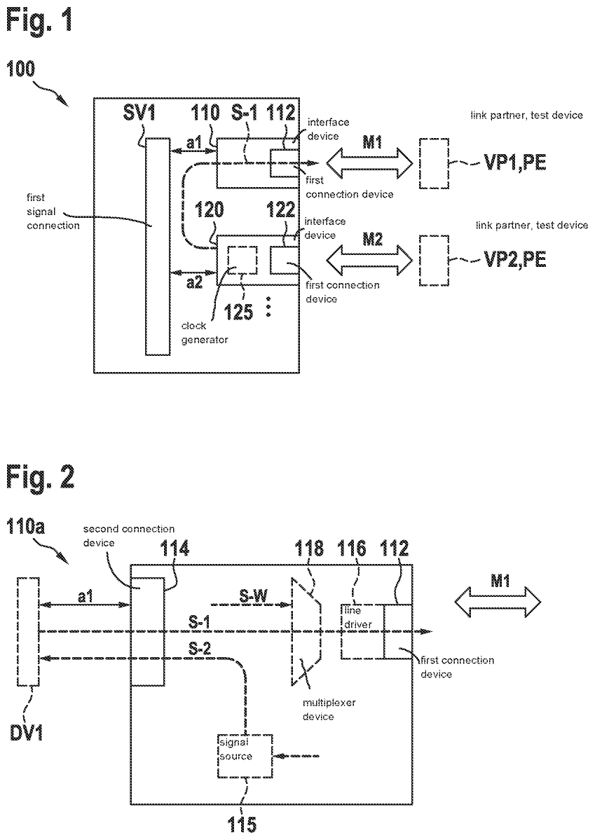

In other embodiment examples, FIG. 2, it is provided that the first interface device 110a comprises a second connection device 114 at least for receiving the first signal S-1 (and/or at least one further, for example internal, signal S-W) from the second interface device 120 (FIG. 1).

In other embodiment examples, FIG. 2, the first interface device 110a can also receive, via the second connection device 114, one or more, e.g. internal, signals, e.g. clock signals, of at least one (for example all) further, i.e. other than the second, interface device, which in other embodiment examples can be output at least temporarily via the first connection device 112 of the first interface device 110, 110a, e.g. analogous to the first signal S-1.

In other embodiment examples, FIG. 2, it is provided that the first interface device 110a is configured to, at least temporarily, via the second connection device 114, output a second signal S-2, for example test signal (which can be generated using a signal source 115, for example, for instance a clock generator and/or a clock recovery unit (see dashed arrow pointing to element 115 according to FIG. 2, which characterizes a signal, for example, on the basis of which the clock recovery unit can derive or recover a clock signal)), to at least one further interface device of the plurality of interface devices, for example to the second interface device 120 (FIG. 1). In other embodiment examples, the second interface device 120, for instance, can be configured, for example in a manner comparable to the first interface device 110, 110a, to at least temporarily receive a signal S-2 from another, e.g. the first (and/or at least one further) interface device, and to output it, for example via the first connection device 122 of the second interface device 120, for example to an external unit PE.

In other embodiment examples, FIG. 2, it is provided that the first interface device 110a is configured to output the first signal S-1 (which it has received from the second interface device 120 (FIG. 1), for example) to at least one further interface device of the plurality of interface devices. The first signal S-1 can thus be forwarded, e.g. by means of the first interface device 110a, to the at least one further interface device, for example for at least temporarily outputting the first signal S-1 via a first connection device (not depicted) of the at least one further interface device, for example to an external unit.

In other embodiment examples, it is provided that the first signal S-1 is not, e.g. not simultaneously or not at all, output via the first connection device 112 of the forwarding first interface device 110 when the first signal S-1 is forwarded to the at least one further interface device.

In other embodiment examples, it is provided that the first signal S-1 is output, e.g. simultaneously, via the first connection device 112 of the forwarding first interface device 110, 110a when the first signal S-1 is forwarded to the at least one further interface device. In some embodiment examples, the first signal S-1 can therefore be output via a respective first connection device 112 of both the forwarding interface device 110, 110a and the at least one further interface device receiving the forwarded first signal, for instance; for example simultaneously, for example to a plurality of test devices PE.

In other embodiment examples, FIG. 2, it is provided that the first interface device 110a comprises a line driver 116 for the first connection device 112, wherein the first interface device 110a is configured to at least temporarily supply the first signal S-1 to the line driver 116.

In other embodiment examples, FIG. 2, it is provided that the first interface device 110a comprises a multiplexer device 118, via which the first signal S-1 or at least one further signal S-W, for example a useful signal, can at least temporarily be supplied to the first connection device 112 and/or a or the line driver 116, for example selectively. In other embodiment examples, the multiplexer device 118 can be controlled for regular operation in such a way that the useful signal S-W can be output via the line driver 116 or the first connection device 112, for instance. In other embodiment examples, the multiplexer device 118 can be controlled for a test operation in such a way that the first signal S-1 or test signal (e.g. clock signal of another interface device 120, . . . ) can be output via the line driver 116 or the first connection device 112, for instance.

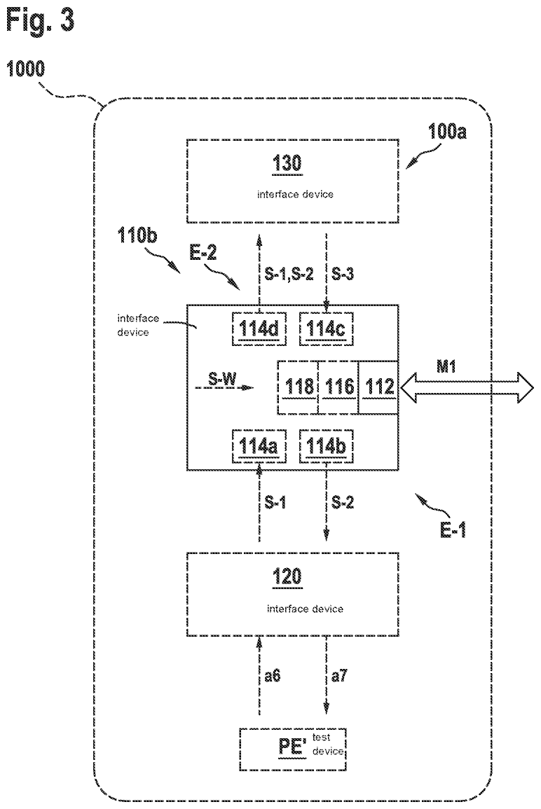

In other embodiment examples, FIG. 3, it is provided that the second connection device 114 (see also FIG. 2) comprises at least one of the following elements: a) a first input 114a for receiving at least one signal, for example the first signal S-1, from the second interface device 120, b) a first output 114b for sending and/or forwarding at least one signal S-2 to the second interface device 120, c) a second input 114c for receiving at least one signal, for example a third signal S-3, from at least one further interface device 130, d) a second output 114d for sending or forwarding at least one signal S-1, S-2 to the at least one further interface device 130. A plurality of interface devices 110b, 120, 130 of the apparatus 100a can thus be efficiently connected to one another in order to, at least temporarily, supply e.g. respective, e.g. internal signals S-1, S-2, S-3 to at least one other interface device, for instance for at least temporarily output via the first connection device 112, 122, . . . of the at least one other interface device and/or for forwarding to at least one further interface device.

In other embodiment examples, it is provided that the same signal, e.g. the signal S-2, is output, for example at least temporarily, for example always, via the two outputs 114b, 114d, for example from the first interface device 110b. In other embodiment examples, therefore, an adjacent interface device 120, 130 can select three options for output, for instance, (e.g. by means of multiplexer device 118):
a) output a signal S-W, for example a useful signal,
b) output the first signal S-1, for example a test signal,
c) output a third signal, for example a test signal from at least one further interface device.

In other embodiment examples, the interface devices 120, 130 according to FIG. 3 have a configuration that is comparable to the configuration 110b according to FIG. 3, for example.

In other embodiment examples, FIG. 3, it is provided that a) the first input 114a and the first output 114b are disposed on a same first side E-1 of the first interface device 110b, for example a carrier (e.g. a circuit carrier plate) for example a substrate, for instance a semiconductor substrate SUBSTR of the interface device, and/or that b) the second input 114c and the second output 114d are disposed on a same second side E-2 of the first interface device 110b, for instance a or the semiconductor substrate SUBSTR of the interface device 110b, wherein the second side E-2 is opposite to the first side E-1, for example. This makes it possible to efficiently bring a plurality of adjacent interface devices 110b, 120, 130 of the apparatus 100a into signal connection with one another and, for instance, enable them to, at least temporarily, exchange, for example internal, signals S-1, S-2, S-3 with one another. The approach according to the embodiment examples is efficiently scalable even for a comparatively large number of interface devices.

In other embodiment examples, it is also possible to dispose a plurality (for example all) of the interface devices of the apparatus on the same substrate, in which case, for instance, the aforementioned principle (sides E-1, E-2) can also be applied with respect to the relative arrangement of individual interface devices with respect to one another.

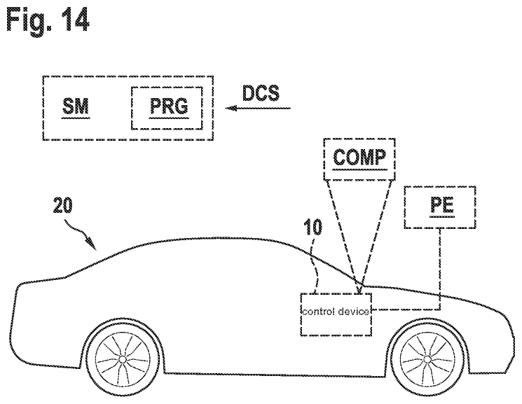

Other embodiment examples, FIG. 3, relate to a system 1000, for example a one-chip system or system on a chip, SoC, 1000 comprising at least one apparatus 100a according to the embodiments. This, for instance, makes it possible to implement communication devices comprising a plurality of interface devices 110, 110a, 110b, 120, 130, . . . , for example for embedded systems, for example for vehicles 20 (see FIG. 14), the internal signals of which can be made available, e.g. efficiently, at least temporarily, to an external unit PE using at least one existing first connection device 112 of at least one interface device 110a, for example for testing purposes, e.g. for a certification and/or qualification and/or characterization and/or production testing and/or the like.

In other embodiment examples, FIG. 3, the system 1000 is configured as an automotive Ethernet SoC 1000, for example; i.e. a single-chip communication device comprising interfaces for automotive Ethernet for the automotive sector, for example.

In other embodiment examples, the apparatus 100, 100a and/or the system 1000 can optionally also include devices (not shown in FIG. 3) for executing functions of higher ISO/OSI layers, e.g. layer 2, 3, etc. In other embodiment examples, the apparatus 100, 100a and/or the system 1000 or the respective plurality of interface devices 110, 110a, 110b, 120, 130 can, e.g. exclusively, comprise devices for executing functions of the ISO/OSI layer 1. In other embodiment examples, combinations of these are possible as well.

Other embodiment examples, FIG. 14, relate to a control device 10, for example for a vehicle 20, for example a motor vehicle 20, comprising at least one apparatus 100, 100a according to the embodiments and/or at least one system 1000 according to the embodiments.

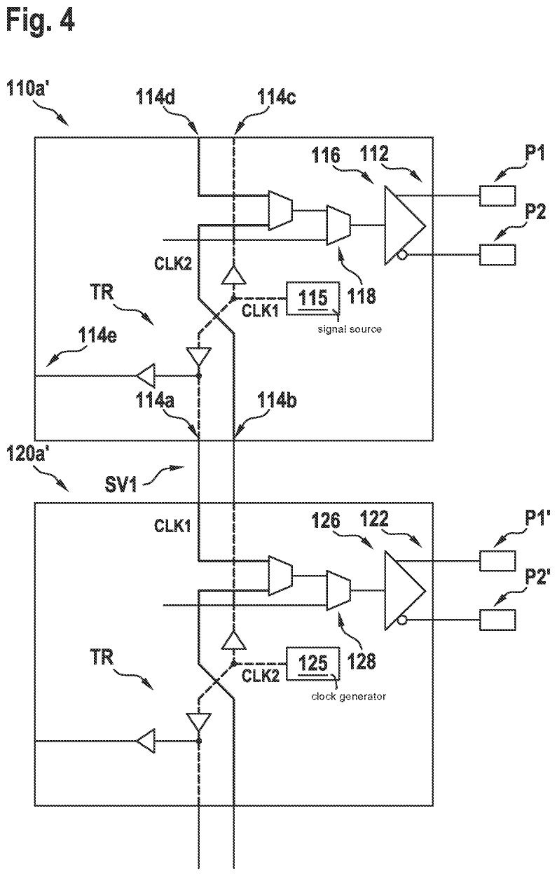

FIG. 4 schematically shows a simplified block diagram according to other embodiment examples. Shown is a first interface device 110a′ with its line driver 116 for the first connection device 112, to which in the present example are assigned two connection pads P1, P2 for a media-dependent interface, via which differential signals S-1, S-W, . . . can be output, e.g. to a link partner VP1 or a test device PE (FIG. 1). Also shown is a multiplexer device 118, and the elements 114a, 114b, 114c, 114d that have already been described above as an example with reference to FIG. 3. One or more TR drivers not individually labeled above can optionally be provided. Further optionally, at least one output 114e for outputting, e.g. the clock signal CLK1, e.g. to a device (e.g. control device, separate output or a multiplexer device) of a SoC 1000 (FIG. 3) can be provided.

The second interface device 120a′, also shown in FIG. 4, has a configuration similar to that of the interface device 110a′ with a line driver 126 for its first connection device 122, to which in the present example are again assigned two connection pads P1′, P2′ for a media-dependent interface via which differential signals S-1, S-W, . . . can be output, e.g. to a link partner VP1 or a test device PE (FIG. 1). A multiplexer device 128 is shown as well. The elements 114a, 114b, 114c, 114d of the second connection device of the second interface device 120a′ are not labeled for the sake of clarity. One or more TR drivers not individually labeled above can optionally be provided.

The interface devices 110a′, 120a′ each have an integrated signal source, e.g. clock generator 115, 125, wherein the clock generator 115 generates or provides a first clock signal CLK1 locally in the first interface device 110a′ or reconstructs it from a further signal, and wherein the clock generator 125 generates or provides a second clock signal CLK2 locally in the second interface device 120a′. The clock signals CLK1, CLK2 can at least temporarily be exchanged between the interface devices 110a′, 120a′ via the first signal connection SV1 according to embodiment examples in the manner already described above as an example with reference to FIGS. 1 to 3, e.g. for at least temporarily outputting e.g. the second clock signal CLK2 via the first connection device 112.

In other embodiment examples, the configuration according to FIG. 4 (possibly plus other e.g. similar interface devices, e.g. “PHY instances”) can be integrated in an SoC 1000 (FIG. 3).

In other embodiment examples, a PAM2, PAM3, PAM4 (two-stage or three-stage or four-stage pulse amplitude modulation) signal, for example, is applied to the connection pads P1, P2 by means of the line driver 112.

In other embodiment examples, the configuration described above as an example with reference to FIG. 3, 4 allows a first interface device to output its clock signal CLK2 to an external unit via the first connection device 112 of a, for example adjacent, second interface device (e.g. disposed on a common substrate SUBSTR adjacent to the first interface device).

The principle according to embodiment examples is shown in FIG. 4 as an example on one clock signal for each interface device 110a′, 120a′ and can be used or transferred to further signals or signal sources per interface device 110a′, 120a in other embodiment examples without loss of generality. In other words, in other embodiment examples, a plurality of signal sources can be provided in one interface device, for example, the signals of which can respectively be forwarded via the first signal connection SV1 to at least one other interface device, for example for output via the first connection device 112 of the at least one other interface device.

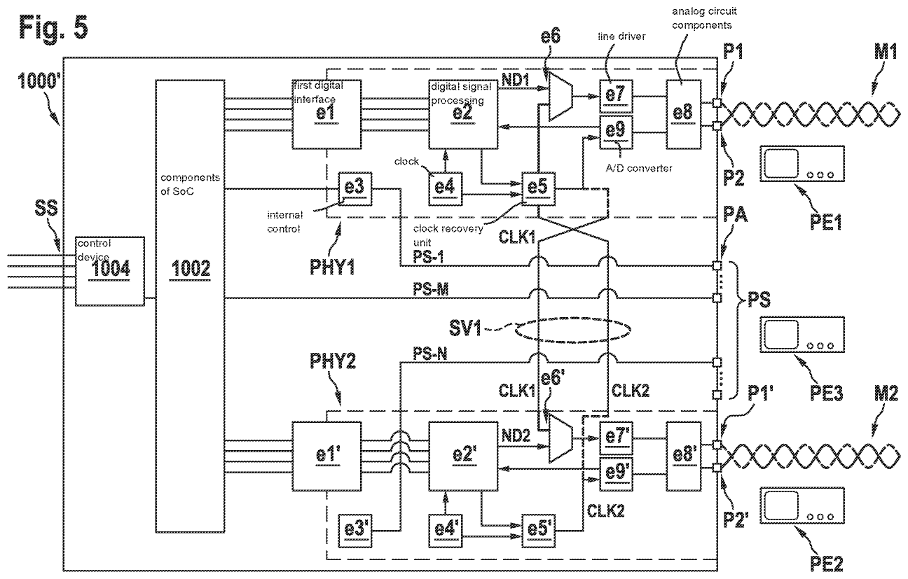

FIG. 5 schematically shows a simplified block diagram of a system, e.g. SoC, 1000′ according to embodiment examples. In the present example, the SoC 1000′ comprises two Ethernet PHY interface devices PHY1, PHY2, which are configured at least similarly to the interface devices 110, 110a, 110b, 120, described above with reference to FIG. 1 to FIG. 4, for instance. The interface device PHY1 comprises a first digital interface e1 to components 1002 of the SoC 1000′, via which an operation of the interface device PHY1 can be controlled by the components 1002, for example; for example exchanging useful data or controlling an operating mode change between a test mode, in which a clock signal CLK2 of the interface device PHY2 can be supplied via the first signal connection SV1 and the connection pads P1, P2 to a first test device PE1, and a regular operating mode, in which a signal ND1 characterizing useful data, for example, can be output via the connection pads P1, P2 or exchanged via the medium M1.

In other embodiment examples, the components 1002 are themselves connected to a control device 1004, which can optionally also control operation of any existing peripheral components (not depicted). The control device 1004 comprises an optional interface SS to at least one external unit (not depicted).

Block e2 of the interface device PHY1 symbolizes a digital signal processing device, Block e3 symbolizes an internal control of the interface device PHY1, Block e4 symbolizes a clock, Block e5 symbolizes a clock recovery unit, Block e6 symbolizes a multiplexer device, e.g. similar to the component 118 according to FIG. 2. Block e7 symbolizes a line driver of the interface device PHY1, Block e8 symbolizes analog circuit components, for example comprising a subtraction device for separating transmit signals and receive signals and/or a filter device, e.g. for pulse shaping and/or conditioning incoming signals at the pads P1, P2, and Block e9 symbolizes an analog-to-digital converter device for transforming incoming signals to a digital domain.

In other embodiment examples, the Blocks e1′, e2′, e3′, e4′, e5′, e6′, e7′, e8′, e9′ of the interface device PHY2 each have a functionality corresponding to the Blocks e1, e2, e3, e4, e5, e6, e7, e8, e9 of the interface device PHY1.

In other embodiment examples, the interface devices PHY1, PHY2 can also be operated at least temporarily such that a clock signal CLK1 of the interface device PHY1 can be supplied to a second test device PE2 via the first signal connection SV1 and the connection pads P1′, P2′, for example via the medium M2.

In other embodiment examples, the SoC 1000′ comprises a test interface PS with a non-vanishing number of test connections which are collectively labeled in FIG. 5 with the reference sign PA. In other embodiment examples, internal signals PS-1, PS-M, PS-N, . . . of the SoC 1000′ can be provided via the test connections PA, for example for the purpose of testing, e.g. a function or for conformity with predeterminable specifications, etc., for at least one external unit, for example a test device PE3.

Advantageously, no test connections PA of the test interface are needed for at least temporarily outputting the clock signals CLK1, CLK2 of the interface devices PHY1, PHY2, for example for testing purposes. Rather, using the principle of the embodiments, the clock signals CLK1, CLK2 can advantageously be exchanged between those of the interface devices PHY1, PHY2, i.e. for example internally within the SoC, via the first signal connection SV1, and the exchanged signals CLK1, CLK2 can at least temporarily be output by a respective first connection device e7, e8, P1, P2 or e7′, e8′, P1′, P2′, for example under the corresponding control of the respective multiplexer device e6, e6′, for example by the respective “PHY-local” control e3, e3′ and/or under the control of components 1002, 1004 of the SoC 1000′. In other words, the number of the PHY interface devices PHY1, PHY2 of the SoC 1000′ can be increased in other embodiment examples without having to provide any or only a smaller number of separate test connections PA at the test interface PS for testing purposes, e.g. in terms of the newly added PHY interface devices. This advantageously makes it possible to keep a total number of test connections PA of the SoC 1000′ comparatively small (“low pin count”).

Outside the test mode, the PHY interface devices PHY1, PHY2 can respectively exchange useful data ND1, ND2, for example, with link partners (not shown in FIG. 5) which are connected via the connection pads P1, P2 or P1′, P2′ or the media M1, M2.

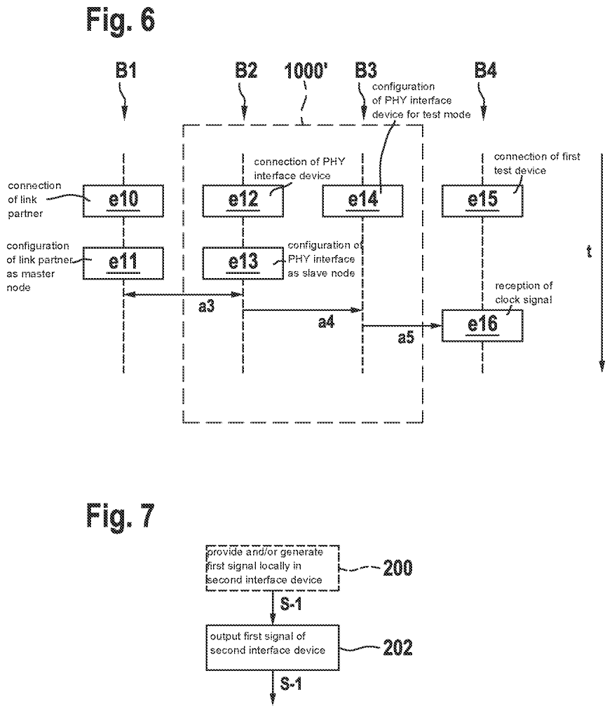

FIG. 6 schematically shows a simplified diagram of a procedure for carrying out a measurement for certification, in which a test signal of a first PHY PHY2 can be measured via the interface device of another PHY PHY1 according to embodiment examples. The reference signs B1, B2, B3, B4 symbolize different regions, wherein the region B1 is assigned to an external link partner, for example, which can be connected to the PHY interface device PHY2 of the SoC 1000′ via a medium M1 (FIG. 5), for instance, wherein the region B2 symbolizes the PHY interface device PHY2 of the SoC 1000′, for example, wherein the region B3 symbolizes the PHY interface device PHY1 of the SoC 1000′, for example, and wherein the region B4 symbolizes a (relative to the SoC 1000′) external test device PE1.

Block e10 symbolizes the connection of the link partner to the PHY interface device PHY2 of the SoC 1000′, Block e11 symbolizes a configuration of the link partner as a master node, and the double arrow a3 symbolizes an activation of the signal connection between the link partner and the PHY interface device PHY2.

Block e12 symbolizes the connection of the PHY interface device PHY2 to the link partner, Block e13 symbolizes a configuration of the PHY interface device PHY2 as a slave node, and arrow a4 symbolizes a forwarding of a clock signal, for example of the type TX_TCLK, from the PHY interface device PHY2 to the PHY interface device PHY1, for example via the first signal connection SV1 (FIG. 1, 5).

Block e14 symbolizes a configuration of the PHY interface device PHY1 for a test mode in which the PHY interface device PHY1 outputs the clock signal a4 received from the PHY interface device PHY2 via the first connection device or the pads P1, P2 to the first test device PE1, see also the arrow a5.

Block e15 symbolizes a connection of the first test device PE1 to the pads P1, P2 of the PHY interface device PHY1, and Block e16 symbolizes a reception by the first test device PE1 of the clock signal of the PHY interface device PHY2 output by means of the first connection device or the pads P1, P2 of the PHY interface device PHY1. The chronological sequence is further illustrated by the time axis t which extends vertically downward in FIG. 6.

Other embodiment examples, FIG. 7, relate to a method for operating an apparatus 100, 100a comprising a plurality of interface devices 110, 120, . . . , wherein the plurality of interface devices each comprise a first connection device for connecting to a transmission medium, wherein the apparatus is configured according to the embodiments, for example, wherein the method comprises: at least temporarily outputting 202 at least a first signal S-1, for example a test signal, of at least one second interface device 120 of the plurality of interface devices via the first connection device 112 (FIG. 1).

In other embodiment examples, FIG. 7, it is provided that the method comprises: providing 200 and/or generating the first signal S-1 locally in the second interface device 120, for example by means of a clock generator 125 and/or a clock recovery unit.

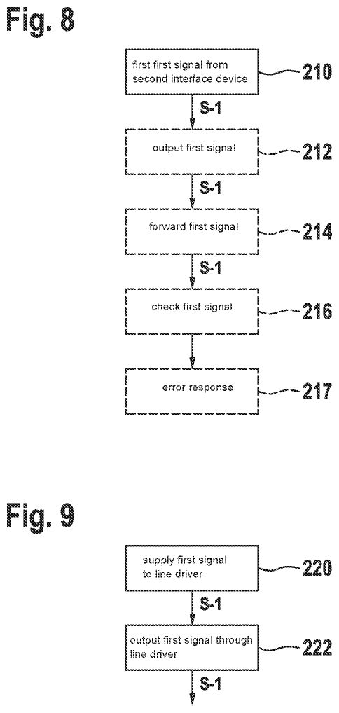

In other embodiment examples, FIG. 8, it is provided that the method comprises at least one of the following elements: a) at least temporarily, receiving 210 the first signal S-1 from the second interface device 120, b) outputting 212 the first signal S-1 via the first connection device 112, c) forwarding 214 the first signal S-1 to at least one further interface device, d) checking 216 the first signal S-1.

In other embodiment examples, it is provided that, e.g. alternatively or additionally for checking or certification purposes, an interface device of the apparatus 100, 100a checks a signal S-1 of at least one other interface device, for example without outputting it via its first connection device 112 and/or forwarding it.

In other embodiment examples, the check 216 can be carried out when the apparatus 100, 100a is activated, for instance, and/or repeatedly, for example periodically, during operation.

In other embodiment examples, for instance, one, e.g. specific, interface device, one or more, e.g. internal, signals of at least one other interface device, for example multiple other interface devices, for example all of the other interface devices of the plurality of interface devices, can be checked 216. The respective signals can be supplied to the checking interface device as described above, for example; for instance at least temporarily via the (internal) signal connection SV1 or the connections or inputs and/or outputs 114, 114a, 114b, described above as examples.

In other embodiment examples, the check 216 can also be carried out by a test device PE (FIG. 3) of the apparatus 100a, which is data-connected to at least one interface device 120 similarly to how the interface devices are connected to one another, in order to exchange the (internal) signals, see the arrows a6, a7 (or at least the receiving direction a7). In other embodiment examples, for example when the apparatus is integrated into a system, e.g.

SoC, 1000, 1000′ the check can also be carried out by a, for example higher-level, test device of the SoC. In other embodiment examples, an error response 217 can be initiated by the checking device if the check 216 (FIG. 8) reveals a faulty signal.

In other embodiment examples, checking 216, so to speak, enables a self-test of the apparatus 100, 100a or the system, e.g. relating to internal signals S-1, S-2, CLK1, CLK2, of the apparatus or its interface devices.

In other embodiment examples, FIG. 9, it is provided that the first interface device 110 (FIG. 2) comprises a line driver 116 for the first connection device 112 and that the method comprises: at least temporarily supplying 220 the first signal S-1 to the line driver 116 and outputting 222 the first signal S-1 through the line driver 116 to the first connection device 112.

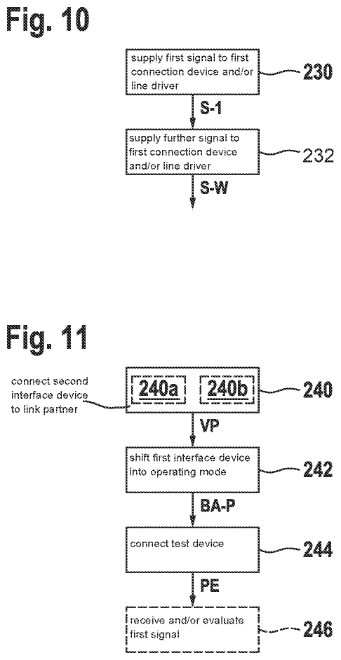

In other embodiment examples, FIG. 10, it is provided that the first interface device comprises a multiplexer device 118 (FIG. 2), and that the method comprises: a) at least temporarily supplying 230, by means of the multiplexer device 118, the first signal S-1 to the first connection device 112 and/or to a line driver 116 for the first connection device 112, b) at least temporarily supplying 232, by means of the multiplexer device 118, at least one further signal S-W, for example a useful signal, to the first connection device 112 and/or to the line driver 116 for the first connection device 112.

In other embodiment examples, FIG. 11, it is provided that the method comprises: connecting 240 the second interface device 120, PHY2 to a link partner VP, wherein the link partner VP is configured 240a as a master, for example, and wherein the second interface device 120, PHY2 is configured 240b as a slave, for example, shifting 242, for example by means of configuration, the first interface device 110, PHY1 into an operating mode BA-P, for example a test mode, in which the first interface device 110, PHY1 is configured to receive the first signal S-1 of the second interface device 120, PHY2 and output it via the first connection device 112 of the first interface device 110, connecting 244 a test device PE to the first connection device 112 of the first interface device 110, and, optionally, receiving 246 and/or evaluating the first signal S-1 output via the first connection device 112 of the first interface device 110 by means of the test device PE.

Other embodiment examples, FIG. 14, relate to a computer-readable storage medium SM comprising instructions PRG that, when executed by a computer COMP, cause said computer to carry out at least some steps of the method according to the embodiments. For example, in other embodiment examples, the computer COMP or a respective functionality can be integrated into the control device 10 or the apparatus 100 (FIG. 1) or the SoC 1000 (FIG. 3).

Other embodiment examples, FIG. 14, relate to a computer program PRG that, when the program PRG is executed by a computer COMP, cause said computer to carry out at least some steps of the method according to the embodiments.

Other embodiment examples relate to a data carrier signal DCS that transmits and/or characterizes the computer program PRG according to the embodiments.

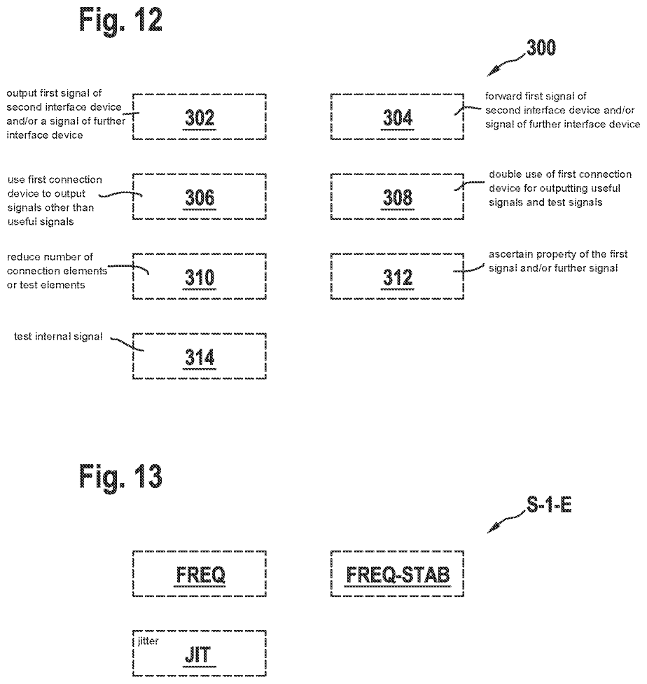

Other embodiment examples, FIG. 12, relate to a use 300 of the apparatus 100, 100a according to the embodiments and/or the system 1000, 1000′ according to the embodiments and/or the control device 10 according to the embodiments and/or the method according to the embodiments and/or the computer-readable storage medium SM according to the embodiments and/or the computer program PRG according to the embodiments and/or the data carrier signal according to the embodiments for at least one of the following elements: a) at least temporarily outputting 302 a first signal S-1 of the second interface device 120 and/or a signal of at least one further interface device via the first connection device 112, for example to a test device PE, b) forwarding 304 the first signal S-1 of the second interface device 120 and/or a signal of at least one further interface device, for example to a device which is external to the apparatus 100, 100a, for example a test device PE, c) at least temporarily using 306 the first connection device 112 to output signals S-1 other than useful signals, for example to output test signals, for example to a device which is external to the apparatus, for example a test device PE, d) double use 308 of the first connection device 112 for at least temporarily outputting useful signals S-W and for at least temporarily outputting test signals S-1, for example to a device which is external to the apparatus, for example a test device PE, e) reducing 310 a number of connection elements or test elements PA (FIG. 5) of the apparatus or the system 1000, 1000′, for example for connecting to at least one external component PE, f) ascertaining 312 at least one property S-1-E (FIG. 13) of the first signal S-1 and/or at least one further signal of at least one interface device of the plurality of interface devices 110, 120, . . . , wherein the at least one property S-1-E comprises at least one of the following elements, for example: f1) frequency FREQ, f2) frequency stability FREQ-STAB, f3) fluctuation, for example clock fluctuation, for example jitter JIT, for example RMS (root mean square) jitter, for example peak-to-peak jitter, f4) TIE (time interval error), f5) phase noise, f6) frequency variation, for example without the use or presence of a separate test connection for outputting the first signal S-1 and/or the at least one further signal of the at least one interface device, g) testing 314 (FIG. 12) an internal signal S-1 of a first interface device 120 of the plurality of interface devices by means of at least one further interface device 110 of the plurality of interface devices.

1-24. (canceled)

25. An apparatus, comprising:
a plurality of interface devices, each of the plurality of interface devices including a respective first connection device configured for connecting to a transmission medium, wherein a first interface device of the plurality of interface devices is configured to at least temporarily output at least a first signal of at least one second interface device of the plurality of interface devices via its respective first connection device.

26. The apparatus according to claim 25, wherein the plurality of interface devices are each configured as Ethernet interface devices.

27. The apparatus according to claim 25, wherein a first signal connection is provided, via which the first signal can at least temporarily be transmitted from the second interface device to the first interface device, wherein the first signal connection is provided internally in the apparatus.

28. The apparatus according to claim 25, wherein the first signal can be generated locally in the second interface device of the plurality of interface devices or can be derived from at least one other signal, wherein the first signal is a clock signal,

29. The apparatus according to claim 25, wherein the first interface device is configured to at least temporarily receive the first signal from the second interface device (via a first signal connection.

30. The apparatus according to claim 25, wherein at least the first interface device includes a second connection device configured at least for receiving the first signal from the second interface device.

31. The apparatus according to claim 30, wherein the first interface device is configured to at least temporarily output a second signal via the second connection device to at least one further interface device of the plurality of interface devices.

32. The apparatus according to claim 25, wherein the first interface device is configured to output the first signal to at least one further interface device of the plurality of interface devices.

33. The apparatus according to claim 25, wherein the first interface device includes a line driver for the first connection device, and wherein the first interface device is configured to at least temporarily supply the first signal to the line driver.

34. The apparatus according to claim 25, wherein the first interface device includes a multiplexer device via which the first signal or at least one further signal can at least temporarily be supplied to the first connection device and/or to a line driver, selectively.

35. The apparatus according to claim 30, wherein the second connection device includes at least one of the following elements: a) a first input for receiving at least one signal, from the second interface device, b) a first output for sending and/or forwarding at least one signal to the second interface device, c) a second input for receiving at least one signal from at least one further interface device, d) a second output for sending or forwarding at least one signal to the at least one further interface device.

36. The apparatus according to claim 35, wherein a) the first input and the first output are disposed on a same first side of the first interface device, and/or b) the second input and the second output are disposed on a same second side of the first interface device, wherein the second side is opposite to the first side.

37. A one-chip system or system on a chip (SoC), comprising:
at least one apparatus including:
a plurality of interface devices, each of the plurality of interface devices including a respective first connection device configured for connecting to a transmission medium, wherein a first interface device of the plurality of interface devices is configured to at least temporarily output at least a first signal of at least one second interface device of the plurality of interface devices via its respective first connection device.

38. A control device for a vehicle, comprising:
at least one apparatus including:
a plurality of interface devices, each of the plurality of interface devices including a respective first connection device configured for connecting to a transmission medium, wherein a first interface device of the plurality of interface devices is configured to at least temporarily output at least a first signal of at least one second interface device of the plurality of interface devices via its respective first connection device.

39. A method for operating an apparatus including a plurality of interface device, each of the plurality of interface devices including a respective first connection device for connecting to a transmission medium, the method comprising:
at least temporarily outputting at least a first signal of at least one second interface device of the plurality of interface devices via the first connection device.

40. The method according to claim 39, further comprising:
providing and/or generating the first signal locally in the second interface device using a clock generator and/or a clock recovery unit.

41. The method according to claim 39, further comprising at least one of the following steps: a) at least temporarily receiving the first signal from the second interface device, b) outputting the first signal via the first connection device, c) forwarding the first signal to at least one further interface device, d) checking the first signal.

42. The method according to claim 39, wherein the first interface device includes a line driver for the first connection device, and wherein the method further comprises:
at least temporarily supplying the first signal to the line driver; and
outputting the first signal through the line driver to the first connection device.

43. The method according to claim 39, wherein the first interface device includes a multiplexer device, and wherein the method further comprises:
a) at least temporarily supplying, using the multiplexer device, the first signal to the first connection device and/or to a line driver for the first connection device,
b) at least temporarily supplying, using the multiplexer device, at least one further signal to the first connection device and/or to the line driver for the first connection device.

44. The method according to claim 39, further comprising:
connecting the second interface device to an external interface device, the external device being a link partner, wherein the link partner is configured as a master, and wherein the second interface device is configured as a slave;
shifting the first interface device into an operating mode in which the first interface device is configured to receive the first signal of the second interface device and output the first signal of the second interface device via the first connection device of the first interface device;
connecting a test device to the first connection device of the first interface device; and
receiving and/or evaluating the first signal output via the first connection device of the first interface device using the test device.

45. A non-transitory computer-readable storage medium on which are stored instructions for operating an apparatus including a plurality of interface device, each of the plurality of interface devices including a respective first connection device for connecting to a transmission medium, the instruction, when executed by a computer, causing the computer to perform the following steps:
at least temporarily outputting at least a first signal of at least one second interface device of the plurality of interface devices via the first connection device.

46. A method of using an apparatus, the method comprising:
providing an apparatus, the apparatus including:
a plurality of interface devices, each of the plurality of interface devices including a respective first connection device configured for connecting to a transmission medium, wherein a first interface device of the plurality of interface devices is configured to at least temporarily output at least a first signal of at least one second interface device of the plurality of interface devices via its respective first connection device; and
using the apparatus for at least one of the following:
a) at least temporarily outputting the first signal of the second interface device and/or a signal of at least one further interface device via the first connection device,
b) forwarding the first signal of the second interface device and/or the signal of at least one further interface device, to a device which is external to the apparatus,
c) at least temporarily using the first connection device to output signals other than useful signals to a device which is external to the apparatus;
d) using the first connection device for at least temporarily outputting useful signals and for at least temporarily outputting test signals to a device which is external to the apparatus;
e) reducing a number of connection elements of the apparatus for connecting to at least one external component;
f) ascertaining at least one property of the first signal and/or at least one further signal of at least one interface device of the plurality of interface devices, wherein the at least one property includes at least one of the following elements: frequency, frequency stability, fluctuation, jitter, without use or presence of a separate test connection for outputting the first signal and/or the at least one further signal of the at least one interface device of the plurality of interface devices;
g) testing an internal signal of the first interface device of the plurality of interface devices using at least one further interface device of the plurality of interface devices.
